(19) United States
(12) Patent Application Publication
(10) Pub. No.: US 2013/0297373 A1
(43) Pub. Date: Nov. 7, 2013

(54) DETECTING PERSONNEL EVENT LIKELIHOOD IN A SOCIAL NETWORK

(71) Applicant: Denys Proux, Eybens (FR)

(72) Inventor: Denys Proux, Eybens (FR)

(73) Assignee: XEROX CORPORATION, Norwalk, CT (US)

(21) Appl. No.: 13/462,002

(22) Filed: May 2, 2012

(51) Int. Cl. G06Q 10/06; G06F 15/16

(52) U.S. Cl. 705/7.28

(57) ABSTRACT

A computer implemented method for calculating the probability of an employee leaving an organization is provided. Closely associated groups of employees within the organization are identified on based on their date of joining the organization. The email traffic among different members of the closely associated group is monitored over a predefined time period. The occurrence of an event in the closely associated group is used to compute a risk parameter for the remaining employees of the closely associated group. The risk parameter is used in conjunction with a first parameter and a second parameter to calculate the probability of an employee leaving the organization.

### COPYRIGHT NOTICE

A portion of the disclosure of this patent document contains material that is subject to copyright protection. The copyright owner has no objection to facsimile reproduction by anyone of the patent document or the patent disclosure as it appears in the Patent and Trademark Office patent file or records but otherwise reserves all copyright rights whatsoever.

### TECHNICAL FIELD

The presently disclosed embodiments are directed to a technique for detecting the occurrence of an event in a social network within an organization. More particularly, the presently disclosed embodiments are directed to a technique for calculating the probability of an employee leaving the organization.

### BACKGROUND

One of the biggest problems which organizations are faced with today is attrition. Experienced people leaving an organization creates not only a negative atmosphere in the workplace but also leads to a lot of time and money being spent by the organization in terms of hiring a new person and training him/her till he/she becomes 100 percent productive.

Traditionally, the senior management and the human resources department in an organization have tried to curtail attrition by increasing the amount spent on employee benefits and giving higher salary packages. However, people in demand seldom have difficulty finding new jobs which pay them more.

In light of the above, what is needed is a system which can help the senior management stay informed of any employee's motivation to leave the organization. This will help them initiate counter-measures before the person actually resigns.

### SUMMARY

According to aspects illustrated herein, there is provided a computer program for calculating the probability of an employee leaving an organization. The computer program comprises program instruction means for identifying a plurality of closely associated groups of employees in the organization based on the employees' date of joining the organization. Further, the code comprises program instruction means for monitoring email traffic between various members of one of the plurality of closely associated groups of employees. Program instruction means are included to calculate a risk parameter for an employee from a particular closely associated group on the basis of any other member of that closely associated group leaving the organization. Further, the computer program comprises program instruction means for calculating the probability of the employee leaving the organization on the basis of the risk parameter, a first parameter, and a second parameter.

According to aspects illustrated herein, there is provided a system for calculating the probability of an employee leaving an organization. The system comprises a closely associated group creation module for creating a plurality of closely associated groups of employees in the organization based on the employee's date of joining the organization. The system also includes an email traffic monitoring module for monitoring e-mail exchange between members of one of the plurality of closely associated groups of employees at a pre-defined time interval. Further, the system comprises a risk calculating module for calculating a risk parameter for an employee in one of the plurality of closely associated groups of employees on the basis of another employee from one of the plurality of closely associated groups of employees leaving the organization. Further, the system includes a resignation probability calculating module for calculating the probability of the employee leaving the organization on the basis of the risk parameter, a first parameter, and a second parameter.

### BRIEF DESCRIPTION OF DRAWINGS

Various embodiments will hereinafter be described in accordance with the appended drawings provided to illustrate and not limit the scope in any manner, wherein like designations denote similar elements, and in which:

FIG. 1 illustrates an organization in accordance with an embodiment;

FIG. 2 is a block diagram illustrating the various components of the system for calculating the probability of an employee leaving an organization in accordance with an embodiment;

FIG. 3 illustrates the representative charts of the impact of the first parameter and the second parameter on the probability of an employee leaving the organization in accordance with an embodiment; and

FIG. 4 is a flowchart illustrating the various steps for calculating the probability of an employee leaving an organization in accordance with an embodiment.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed description given herein with respect to these figures is just for explanatory purposes as the method and the system extend beyond the described embodiments. For example, those skilled in the art will appreciate, in light of the teachings presented, recognizing multiple alternate and suitable approaches, depending on the needs of a particular application, to implement the functionality of any detail described herein, beyond the particular implementation choices in the following embodiments described and shown.

A system and a computer code for calculating the probability of an employee leaving an organization are provided. It is common knowledge that attrition is one of the main problems plaguing organizations these days. Employees tend to leave an organization for many reasons. These can be personal such as the spouse of an employee moving to a different city, and an employee wanting to move back to his/her home town, etc. Other reasons can be circumstantial such as the employee leaving the organization for a better pay somewhere else or because the employee does not get along with his/her boss. Yet another reason, which goes un-noticed to some extent, is the influence an employee's peer group in the organization has on the said employee. Humans in general succumb to events that happen around them. In the present situation, if a close colleague of an employee leaves the organization for another job, the said employee is also tempted to consider looking for other jobs. It is an objective of the disclosed embodiments to calculate the probability of an employee leaving the organization based on his/her degree of isolation. The disclosed embodiments provide means to identify closely associated groups within an organization. Any event, such as one employee leaving the organization, will have an impact on all members of this closely associated group. If such groups and the impact of one person leaving the organization on another employee in the same group can be identified, then the same can be notified to the human resources (HR) department of the organization. If the employee is of importance to the organization, the HR department can take the necessary measures to ensure retention of the said employee. A detailed description of various embodiments will now be provided in conjunction with the appended drawings.

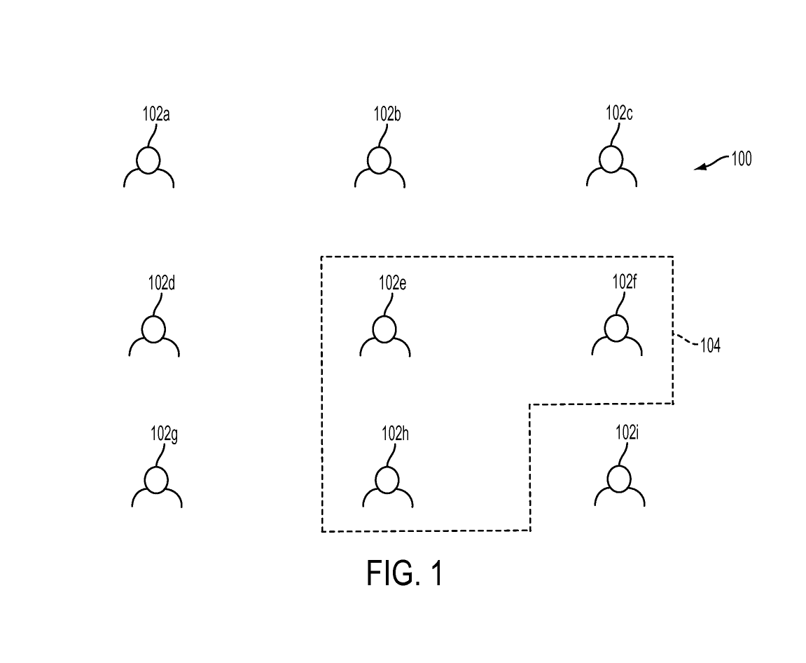

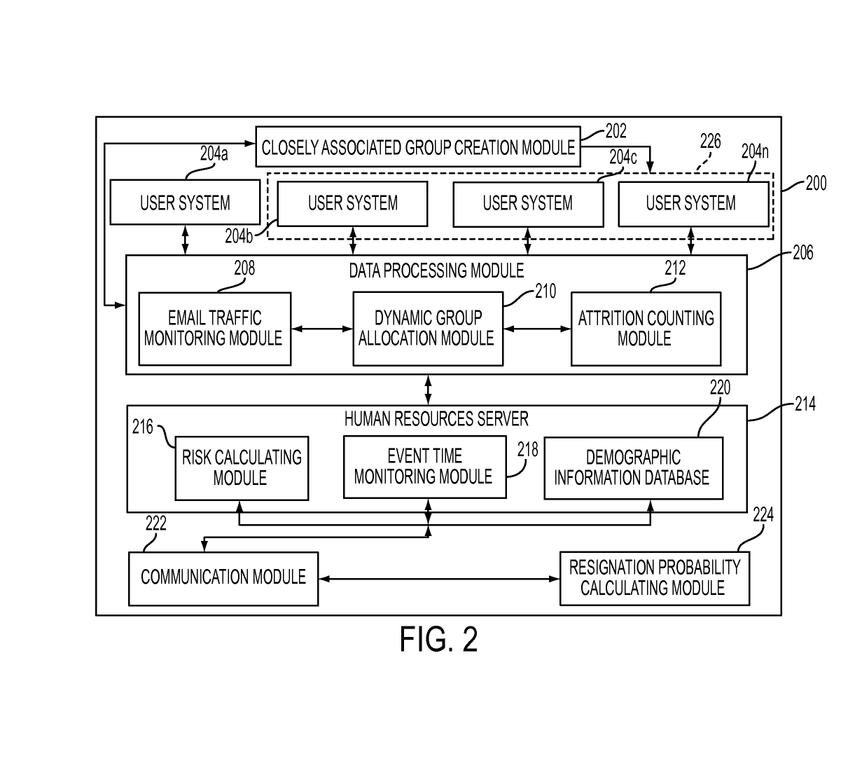

FIG. 1 illustrates an organization in accordance with an embodiment. The various employees of the organization are represented by 102a to 102i. A group of employees who are closely associated with one another is depicted by 104. It is understood that a plurality of such groups will exist in an organization. Such closely associated groups are typically characterized by the fact that the members perform a lot of activities together. These activities can be eating lunch together, going for smoke breaks, etc. In order to calculate the effect of one employee leaving the organization on another employee from the same closely associated group, it is imperative to first identify these closely associated groups. The means and process to identify these closely associated group will now be discussed in more detail in conjunction with the explanation for FIG. 2.

FIG. 2 is a block diagram illustrating the various components of the system for calculating the probability of an employee leaving an organization in accordance with an embodiment. System 200 comprises a closely associated group creation module 202, and user systems 204a to 204n. System 200 further comprises a data processing module 206, which in turn comprises an email traffic monitoring module 208, a dynamic group allocation module 210, and an attrition counting module 212. Also included in the system 200 is a human resources server 214, which in turn comprises a risk calculating module 216, an event time monitoring module 218, and a demographic information database 220. System 200 lastly comprises a communication module 222 and a resignation probability calculating module 224. Suitable interconnection between various elements of the system 200 is represented by line connectors in FIG. 2.

The system 200 comprises various user systems 204a to 204n. These user systems represent the workstations of various employees in the organization. A closely associated group creation module 202 is provided. The closely associated group creation module 202 is responsible for identifying various closely related groups in the organization. For example, in an embodiment, one closely related group within the organization is represented by 226. The means to identify closely associated groups within the organization will now be explained in more detail in the foregoing description.

Employees form social networks in the organization that they work in. Since a large part of the day of a person is spent at his/her office, it is but natural for them to form bonds with other co-workers. These bonds or closely associated groups are characterized by the fact that their members perform various activities together. One way of coordinating these various activities is over email. Further, a group of employees joining an organization around the same time tend to be more closely associated with each other, than with employees who have been in the organization before them. The closely associated group creation module 202, as a first step, identifies the various people in an organization who have joined in a period of one month. For the simplicity of explanation, a period of one month has been considered. However, various other time frames can also be considered without limiting the scope of the ongoing description. The groups of people who have been identified as the ones who joined the organization around the same time are an extension of the closely associated group of employees 226. Over time, some employees who joined at the same time lose contact with each other. However, a plurality of employees who joined together still stay in touch and become part of a closely associated group 226. This group spends a lot of time together doing various activities such as coffee breaks, lunch, etc. In order to communicate with each other, the various employees in the closely associated group of employees 226 can choose to use a plurality of mediums. These mediums can be, but are not restricted to, emails, Instant Messaging, etc. In an embodiment, the email traffic monitoring module 208 checks the addresses of the recipients of emails going out from various user systems covered under the closely associated group of employees 226. The email traffic monitoring module 208 is also configured to record the time of the day at which the email is being sent out. It will be apparent to one skilled in the art that the traffic monitoring module does not invade an employee's privacy by scanning/reading the content of his/her emails or checking for specific key words in the email. Only specific attributes of the email, that is, addresses of the recipients and time of the email are recorded by the email traffic monitoring module 208. Among the activities which the closely associated groups perform together, one activity is going for lunch together. Further, it can be safely assumed that the time for lunch is pre-determined in most organization and almost all employees adhere to it. In another embodiment, the data collected by the email traffic monitoring module 208 can be used to allocate different lunch times to different closely associated groups within the organization.

The email traffic monitoring module 208 will continuously check the addresses of the recipients of the emails going out from user systems one hour before lunch time. It will be appreciated that the time frame of one hour has been used as an example and that other time frames are possible depending upon the particular office timings of an organization in accordance with various embodiments. In another embodiment, the email traffic monitoring module 208 can also be configured to scan the emails for keywords such as “Lunch,” in order to make the identification of the closely associated groups more accurate. It will be understood by a person ordinarily skilled in the art that the email traffic monitoring module 208 can be replaced by another module to monitor the exchange of instant messages. The information from email traffic monitoring module 208 is communicated to the closely associated group creation module 202, which will compile this information with the originally identified group of employees who joined around the same time to identify the various closely related groups in the organization.

In an embodiment, the various identified closely associated groups can change over time. For example, new members may be added or old members may join other closely associated groups. The dynamic group allocation module 210 also receives email traffic information from the email traffic monitoring module 208. The information received will be used by the dynamic group allocation module 210 to update the various closely associated groups and convey the information to the closely associated group creation module 202.

The attrition counting module 212 is provided which constantly records information about the departure of any employee from the organization. This information is used in conjunction with the information in the dynamic group allocation module 210, which then updates the information about changes in group membership and relays the same to the closely associated group creation module 202. The email traffic monitoring module 208, the dynamic group allocation module 210, and the attrition counting module 212 are part of a data processing module 206, which in turn is connected to a Human Resources server 214. An occurrence of the departure of an employee recorded in the attrition counting module 212 is conveyed to the human resources server 214.

The human resources server 214 comprises the risk calculating module 216, event time monitoring module 218, and the demographic information database 220.

When an employee from a particular closely associated group leaves the organization, the risk calculating module 216 calculates a risk parameter for the remaining members of that particular closely associated group. In an embodiment, the risk parameter can be considered to be a degree of isolation (DOI) for an employee and can be calculated according to the following formula:

DOI=(NME+1)/NMB;

wherein,

NMB=Initial number of members in the closely associated group; and

NME=Number of members of the closely associated group who have left the organization.

It will be appreciated that any other suitable equations may also be used to calculate the degree of isolation for an employee without limiting the scope of the disclosed embodiments. The degree of isolation for a particular employee represents the likelihood of an employee leaving the organization. For example, we can consider a closely associated group with five employees. If three of the members leave the organization, then the DOI or risk parameter for the remaining two members of the closely associated group can be calculated as follows:

DOI=(3+1)/5=0.8 (or 80%).

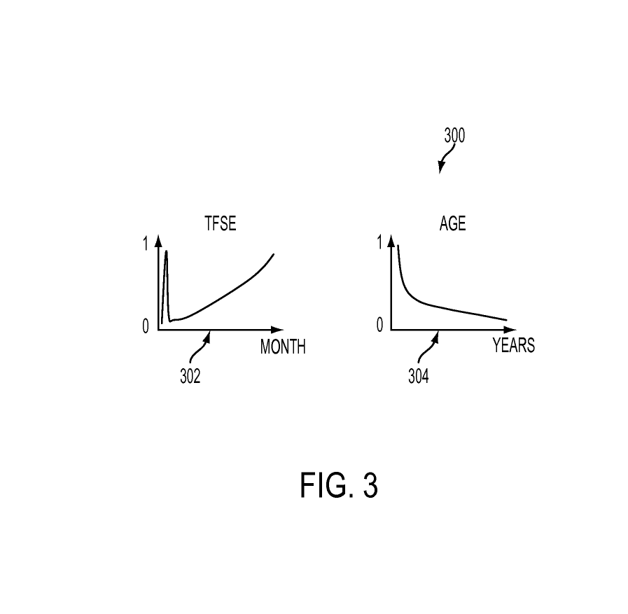

In accordance with the various embodiments, the risk parameter or degree of isolation for the remaining employees calculated by the risk calculating module 216 is further appended with a first parameter and a second parameter in order to calculate the probability of an employee leaving the organization. The calculation of the first and second parameters will now be explained in conjunction with the explanation for the remaining elements of 200 and FIG. 3.

FIG. 3 illustrates the representative charts of the impact of the first parameter and the second parameter on the probability of an employee leaving the organization in accordance with an embodiment. In an embodiment, the first parameter to be used in the calculation of the probability of an employee leaving the organization is the average time spent by employees in an organization. It will be appreciated by a person skilled in the art that the calculation of the average time spent by employees in an organization will be performed by observation of historical data on the attrition in an organization. The average time spent by an employee in an organization before leaving is an indicator of the trend of the attrition within the organization and represents the time spent by employees in the organization before they resign from their job to join another organization. The chart for the average time spent by employees in an organization is illustrated by 302. The event time monitoring module 218 is configured to calculate the first parameter for an employee in the closely associated group in which a member has resigned, by placing the time spent in the organization by the remaining employees of the closely associated group on the curve for the average time spent by employees in that organization. The time already spent by an employee in the organization can be located on the curve for the average time spent by employees in that organization. The point at which the time already spent by the employee in the organization is located on the curve represents the first parameter which will be factored in to calculating the probability of that employee leaving the organization.

In an embodiment, the second parameter which is considered for calculating the probability of an employee leaving the organization is the age of the employee. It is common knowledge that people tend to be more experimental in terms of their careers when they start working. However, with age come added responsibilities of a family, mortgage, other expenses, and so forth. Due to these various constraints, employees are typically reluctant to look out for new jobs at an older age. The impact of the age of an employee on his decision to leave an organization is represented by 304. In an embodiment, the demographic information database 220 includes the age information for all the employees, which can be considered for calculating the probability of an employee leaving the organization. As used herein, the demographic information of an employee includes information which is readily and legally obtainable. Such information can include, the age of the employee, location of the employee, etc.

The information from the risk calculating module 216, the event time monitoring module 218, and the demographic information database 220 is passed on to a communication module 222. The communication module 222 then collates all the information for employees of various closely associated groups and passes it on to resignation probability calculating module 224. The resignation probability calculating module 224 uses the information to calculate the probability of a particular employee leaving an organization. In an embodiment, the probability value can be calculated using the following mathematical formula:

Probability of an employee leaving the organization=[Risk parameter+a((first parameter×(1+second parameter))/2]/(1+a).

In the above equation, ‘a’ is a constant which is used to provide a weight to the first and second parameters with respect to the risk parameter. In an embodiment, it can be considered that the DOI or risk parameter is an internal parameter, that is, dependent not only on the particular employee but on the entire closely associated group of the employee. However, the first and second parameters, which represent an employee's age and time spent in the organization are external parameters. An external parameter implies that these values are not dependent on the employee's closely associated group. In the above equation, ‘a’ provides a weightage, which can be based on historical values, to the external parameters. For example, an employee may have a risk parameter of 0.8 (80%) based on the number of resignations in his closely associated group. However, the employee is very old but has not spent too much time in the organization. This implies that the second parameter for this particular employee will be very strong (low on the graph for age) and the first parameter will be medium (0.5). Based on historical values, the human resources department can decide that the age of this particular employee is very high and hence he has a very low probability of leaving the organization inspite of the high degree of isolation. Based on this, a high value of ‘a,’ such as 0.9, can be used in the equation to provide an increased weightage to the external parameters. Using the above values in the equation, the probability of this particular employee leaving the organization can be calculated as:

Probability of an employee leaving the organization=[0.8+0.9((0.2×(1+0.5))/2]/(1+0.9).

This gives a probability of resignation value as 0.435 or approximately 44%. This implies that although the degree of isolation for this particular employee is very high, his probability of leaving the organization is low due to external parameters.

It will be understood and appreciated by a person ordinarily skilled in the art that the calculation of the value of ‘a’ is based on historical trends of attrition within the organization. In an embodiment, the historical trend can be observed over a predefined time duration of two years. It will be appreciated that the pre-defined time duration of two years can vary in accordance with the needs of an organization without departing from the scope of the various embodiments.

The calculation of the probability of an employee leaving the organization can then be communicated to the human resources department, which can judge whether a particular employee is valuable enough to be retained with additional perks.

In another embodiment, a particular employee can be a member of more than one closely associated group. For such an employee, the risk parameter will be calculated for all the closely associated groups that he/she is a member of and a weighted average of all the risk parameters can be calculated in order to determine the accurate risk parameter for that employee.

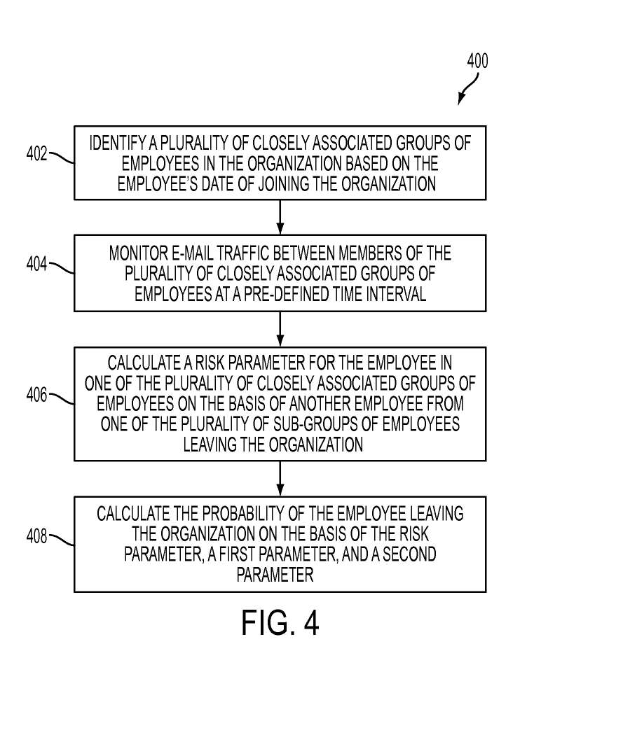

FIG. 4 is a flowchart illustrating the various steps of calculating the probability of an employee leaving an organization in accordance with an embodiment. At 402, a plurality of closely associated groups of employees is identified within the organization. The email traffic between various members of the identified closely associated group is monitored at 404. As explained in the detailed description of FIG. 2, the exchange of information between members of the closely associated group of employees need not only be restricted to email and can also cover messages exchanged over an instant messenger (IM) among other modes of communication.

At 406, a risk parameter for an employee in a given closely associated group is calculated on the basis of other employees from said closely associated group leaving the organization. At 408, the risk parameter, a first parameter, and a second parameter are used to calculate the probability of an employee leaving the organization. The calculation of the first and second parameters has been explained in the detailed description of FIGS. 2 and 3. On the basis of the calculated probability, the human resources department of the organization can take necessary measures to retain the employee depending on the level of importance of the employee.

It will be appreciated by a person skilled in the art that the term ‘average,’ as used herein can apply to any mathematical process by which a plurality of data is effectively summarized by one datum or a smaller number of data.

It will be appreciated by a person skilled in the art that the system, modules, and sub-modules have been illustrated and explained to serve as examples and should not be considered limiting in any manner. It will be appreciated that the variants of the above disclosed system elements, or modules and other features and functions, or alternatives thereof, may be combined to create many other different systems or applications.

The method and system described above have numerous advantages. The various embodiments propose a process for calculating the probability of an employee leaving an organization based on the developments within his peer group in the organization. It will be appreciated by a person skilled in the art that the disclosed embodiments achieve the objective of calculating this probability by considering only the correlation between a few parameters which are easily obtainable. The disclosed embodiments, further, does not impinge on an employee's privacy since no emails are read or scanned and only certain attributes such as recipient names and time of sending the email are recorded.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

What is claimed is:

1. A method for calculating a probability of an employee leaving an organization, the method comprising:
in a computer:
identifying a plurality of groups of employees performing at least one common activity in the organization, wherein the at least one common activity comprises at least an employee's date of joining the organization;
monitoring e-mail traffic among members of one of the plurality of groups of employees at a pre-defined time interval;
calculating a risk parameter for the employee in one of the plurality of groups of employees on the basis of an another employee from the one of the plurality of groups of employees leaving the organization; and
calculating the probability of the employee leaving the organization on the basis of the risk parameter, a first parameter, and a second parameter.

2. The method of claim 1, wherein monitoring email traffic comprises recording names of senders and recipients of emails.

3. The method of claim 1, wherein monitoring email traffic comprises recording time of sending the email.

4. The method of claim 1, wherein monitoring email traffic does not comprise reading a content of the email.

5. The method of claim 1, wherein the employee can be a member of more than one of the plurality of groups of employees.

6. The method of claim 1 further comprising calculating more than one risk parameter for the employees who belong to more than one of the plurality of groups of employees.

7. The method of claim 6 further comprising calculating a weighted average of the more than one risk parameter.

8. The method of claim 1, wherein the first parameter is obtained as a function of the average time spent by the employees in the organization before resigning.

9. The method of claim 1, wherein the second parameter corresponds to a demographic information of the employee.

10. The method of claim 1 further comprising monitoring over a pre-defined time a relation first and second parameter, and a member of one of the plurality of groups of employees leaving the organization.

11. A computer program product for use with a computer, the computer program product comprising a non-transitory computer usable medium having a computer readable program code embodied therein for calculating a probability of an employee leaving an organization, the computer readable program code is used by the computer to:
identify a plurality of groups of employees performing at least one common activity in the organization, wherein the at least one common activity comprises at least an employee's date of joining the organization;
monitor e-mail traffic among members of one of the plurality of groups of employees at a pre-defined time interval;
calculate a risk parameter for the employee in one of the plurality of groups of employees on the basis of an another employee from the one of the plurality of groups of employees leaving the organization; and
calculate the probability of the employee leaving the organization on the basis of the risk parameter, a first parameter, and a second parameter.

12. The computer program product of claim 11, wherein monitoring email traffic comprises recording names of senders and recipients of emails.

13. The computer program product of claim 11, wherein monitoring email traffic comprises recording time of sending the email.

14. The computer program product of claim 11, wherein monitoring email traffic does not comprise reading a content of the email.

15. The computer program product of claim 11, wherein the employee can be a member of more than one of the plurality of groups of employees.

16. The computer program product of claim 11, wherein the computer readable program code is further used by the computer to calculate more than one risk parameter for the employees who belong to more than one of the plurality of groups of employees.

17. The computer program product of claim 11, wherein the computer readable program code is further used by the computer to calculate a weighted average of the more than one risk parameter.

18. The computer program product of claim 11, wherein the first parameter is obtained as a function of the average time spent by the employees in the organization before resigning.

19. The computer program product of claim 11, wherein the second parameter corresponds to a demographic information of the employee.

20. The computer program product of claim 11, wherein the computer readable program code is further used by the computer to monitor over a pre-defined time a relation first and second parameter and a member of one of the plurality of groups of employees leaving the organization.
